(19) United States
(12) Patent Application Publication
(10) Pub. No.: US 2023/0246466 A1
(43) Pub. Date: Aug. 3, 2023

(54) SYSTEMS AND METHODS FOR CHARGING BATTERIES

(71) Applicant: Medtronic, Inc., Minneapolis, MN (US)

(72) Inventor: Joseph J. Viavattine, Vadnais Heights, MN (US)

(21) Appl. No.: 18/080,536

(22) Filed: Dec. 13, 2022

Related U.S. Application Data
(60) Provisional application No. 63/305,939, filed on Feb. 2, 2022.

(51) Int. Cl. H02J 7/00; H01M 10/44

(52) U.S. Cl. CPC H02J 7/0049; H01M 10/44; H02J 7/0069

(57) ABSTRACT

Methods, apparatus, and systems, for charging a battery are disclosed. Charging the battery may include charging the battery to a predetermined state of charge using a plurality of charging cycles. Each of the plurality of charging cycles may include charging the battery to increase a state of charge of the battery from an initial-cycle state of charge to an intermediate-cycle state of charge at a charge rate. Each of the plurality of charging cycles further include discharging the battery to decrease the state of charge of the battery from the intermediate-cycle state of charge to a final-cycle state of charge at a discharge rate faster than the charge rate. Additionally, the increase of the state of charge is at least twice as much as the decrease of the state of charge.

### RELATED PATENT APPLICATION

This application claims the benefit of U.S. Provisional Patent Application Ser. No. 63/305,939, filed on Feb. 2, 2022, which is incorporated by reference herein in its entirety.

### FIELD

The present disclosure relates to, among other things, rechargeable batteries or electrochemical cells.

### TECHNICAL BACKGROUND

Rechargeable batteries or electrochemical cells (i.e., rechargeable or “secondary” batteries) include one or more positive electrodes, one or more negative electrodes, and an electrolyte provided within a case or housing. Separators made from a porous polymer or other suitable material may also be provided intermediate or between the positive and negative electrodes to prevent direct contact between adjacent electrodes. The positive electrode includes a current collector having an active material provided thereon, and the negative electrode includes a current collector having an active material provided thereon.

Rechargeable lithium metal batteries are desirable for their relatively high energy density. However, it can be challenging to recharge a lithium metal battery quickly without negatively impacting performance of the battery. Limitations to recharge lithium metal batteries can include a kinetic limitation that relates to battery impedance. Battery impedance can lead to peaked or mountainous lithium plating with a sufficiently high charging current. Such peaks in lithium plating may accelerate capacity loss and degradation of the battery that may lead to failure. Slower charging may result in a more uniform (e.g., flatter) lithium plating topology; however, keeping the charging current low enough to prevent peaks in lithium plating may result in lengthy charging times for batteries. Accordingly, a charging rate may be chosen to strike a balance between a battery charge time and a usable life of the battery. A lower charge current may cause lengthy charging times of the battery that may not be favorable for a user. Additionally, such charging times may further increase as the battery ages because battery resistance typically grows as the battery ages.

### BRIEF SUMMARY

As described herein, fast recharging of lithium metal batteries, while reducing undesirable lithium plating topography, can be achieved using a plurality of charge cycles that include charging a portion of a batteries capacity at a charging rate and discharging a smaller portion of the batteries capacity at an accelerated rate relative to the charging rate. Charging batteries fast enough to avoid extended charging times may be fast enough to cause lithium plating with a peaked or mountainous topography. However, discharging a smaller portion of the charged capacity at a rate faster than the charging rate may reduce or eliminate such peaks in lithium plating resulting in a more uniform (e.g., flatter) lithium plating topography. Accordingly, charging voltage for recharging such lithium metal batteries may be large at the outset to permit fast recharge and may be increased as the battery ages to maintain similar charging times without substantial performance degradation.

Described herein, among other things, is a method comprising charging a battery to a predetermined threshold state of charge using a plurality of charge cycles. Each of the plurality of charge cycles comprising charging the battery to increase a state of charge of the battery from an initial-cycle state of charge to an intermediate-cycle state of charge at a charge rate and discharging the battery to decrease the state of charge of the battery from the intermediate-cycle state of charge to a final-cycle state of charge at a discharge rate faster than the charge rate. Additionally, the increase of the state of charge is at least twice as much as the decrease of the state of charge.

In general, in one aspect, the present disclosure describes a battery charging apparatus comprising a charger to charge one or more batteries, a discharger to discharge the one or more batteries, and a computing apparatus. The computing apparatus comprises one or more processors operably coupled to the charger and the discharger. The computing apparatus is configured to charge a battery to a predetermined threshold state of charge using a plurality of charge cycles. Each of the plurality of charge cycles comprises charging the one or more batteries to increase a state of charge of the battery from an initial-cycle state of charge to an intermediate-cycle state of charge at a charge rate using the charger and discharging the one or more batteries to decrease the state of charge of the battery from the intermediate-cycle state of charge to a final-cycle state of charge at a discharge rate faster than the charge rate using the discharger. Additionally, the increase of the state of charge is at least twice as much as the decrease of the state of charge.

In general, in another aspect, the present disclosure describes a system comprising a charging apparatus for charging one or more batteries, a discharge apparatus for discharging the one or more batteries, a battery operatively coupled to the charging apparatus, and battery management system. The battery comprises one or more electrochemical cells. The battery management system comprises one or more processors and is operably coupled to the one or more electrochemical cells. The battery management system is configured to charge the battery to a predetermined threshold state of charge using a plurality of charge cycles. Each of the plurality of charge cycles comprises charging the battery to increase a state of charge of the battery from an initial-cycle state of charge to an intermediate-cycle state of charge at a charge rate and discharging the battery to decrease the state of charge of the battery from the intermediate-cycle state of charge to a final-cycle state of charge at a discharge rate faster than the charge rate. Additionally, the increase of the state of charge is at least twice as much as the decrease of the state of charge.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is a schematic block diagram of an embodiment of a battery charging apparatus and a device;

FIG. 2 is a schematic block diagram of an embodiment of a battery charging apparatus;

FIG. 3 is a schematic block diagram of at least a portion of a discharge circuit;

FIG. 4 is a schematic block diagram of a switching load network of a discharge circuit;

FIG. 5 is a schematic representation of an embodiment of a rechargeable battery; and

FIG. 6 is flow diagram of an embodiment of a process for determining a charging voltage of a battery.

The schematic drawing is not necessarily to scale.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Fast recharging of lithium batteries, while reducing undesirable lithium plating topography, can be achieved by alternating periods of charging and discharging during a battery charging method or process. In general, fast charging of rechargeable batteries is desired to maximize use time and/or minimize recharge burden. Additionally, lower power consumption for devices that use rechargeable batteries is desired and, generally results in slow discharging of rechargeable batteries. By charging quickly and discharging slowly, the ratio of the use time of battery powered devices to the downtime may be maximized. However, it has been found that fast charging of lithium batteries coupled with slow discharging generally yields a “mountainous” (e.g., peaks and valleys, non-uniform) lithium plating topography. Fast charging of lithium batteries may cause uneven lithium plating resulting in peaks and valleys. Conversely, slow discharging may remove lithium plating uniformly and, therefore, leave the peaks and valleys of the lithium plating intact. Accordingly, as the battery ages, lithium plating structures may become increasingly detrimental to battery performance including, for example, isolated lithium that cannot contribute to energy storage and delivery, loss of battery capacity, and increased internal resistance of the battery.

However, fast discharging of batteries may remove lithium plating in a manner that reduces peaks in lithium plating. Furthermore, the effects of lithium plating during charging and plating removal during discharging may be proportional to the rates of charging and discharging. Accordingly, charging a battery with alternating periods of charging and discharging, where the capacity charged is greater than the capacity discharged, and the rate of discharge is greater than the rate of charge may result in a more uniform distribution or topology of lithium plating. A more uniform topology of lithium plating may mitigate the negative effects of peaked lithium plating, thereby extending battery life and reducing the risk of battery failure.

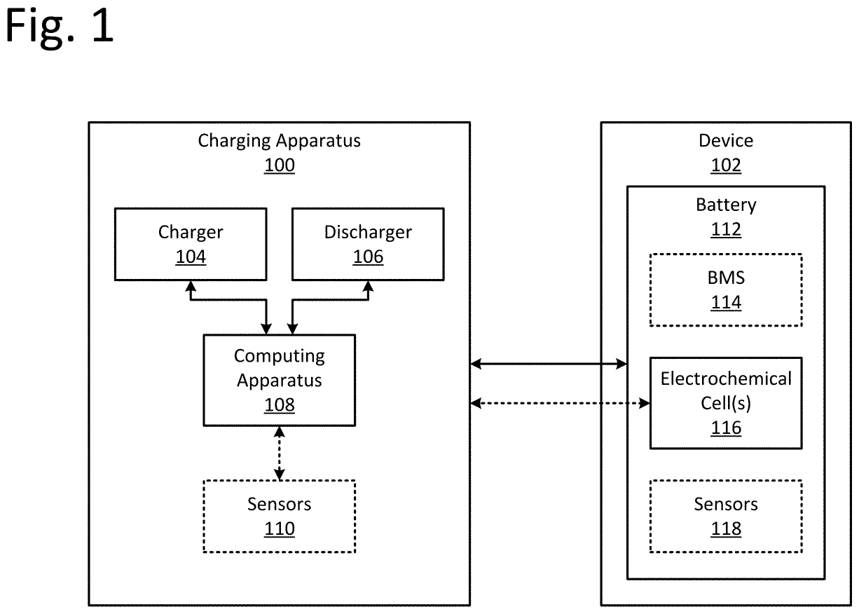

A charging apparatus for charging a battery using alternating periods of charging and discharging is depicted in FIG. 1. FIG. 1 shows schematic block diagram of a charging apparatus 100 and a device 102.

The charging apparatus 100 includes a charger 104, a discharger 106, and a computing apparatus 108. The charging apparatus 100 may optionally include one or more sensors 110. The charging apparatus 100 may include a housing (not shown) to house the charger 104, the discharger 106, and the computing apparatus 108. The housing may also house the sensors 110.

The device 102 includes battery 112. Although only shown with a single battery (e.g., battery 112), the device may include multiple batteries. The battery 112 may include one or more electrochemical cells 116, a battery management system (BMS) 114, and one or more sensors 118. The device 102 may be a medical device. The medical device may be, for example, an implantable neurostimulator, ventilator, surgical stapler, or medical monitoring equipment.

The charger 104 may be configured to charge the battery 112. Although only one battery is shown, the charger 104 may be configured to charge multiple batteries. The charger 104 may include any suitable circuitry or electronics to charge the battery 112 such as, e.g., a power source, rectifier circuit, power circuit, control circuit, regulator circuit, fault detection circuit, etc. The charger 104 may be operably coupled to the computing apparatus 108. The charger 104 may be operable or controllable (e.g., by the computing apparatus 108) to charge the battery 112 at any suitable rate, current, voltage, etc. The charger 104 may be operable or controllable to charge the battery 112 at a constant current or a constant voltage.

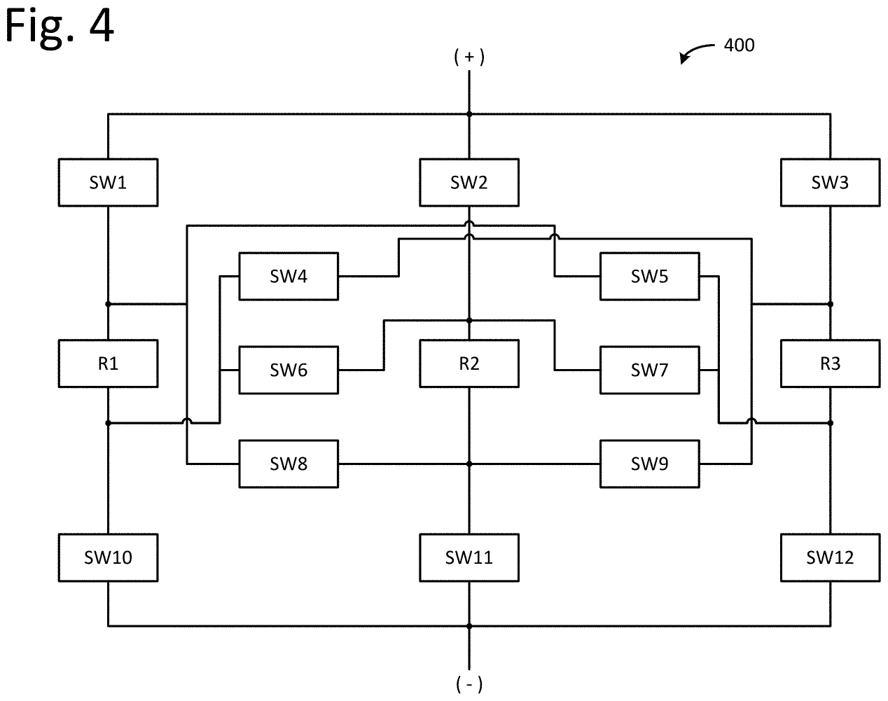

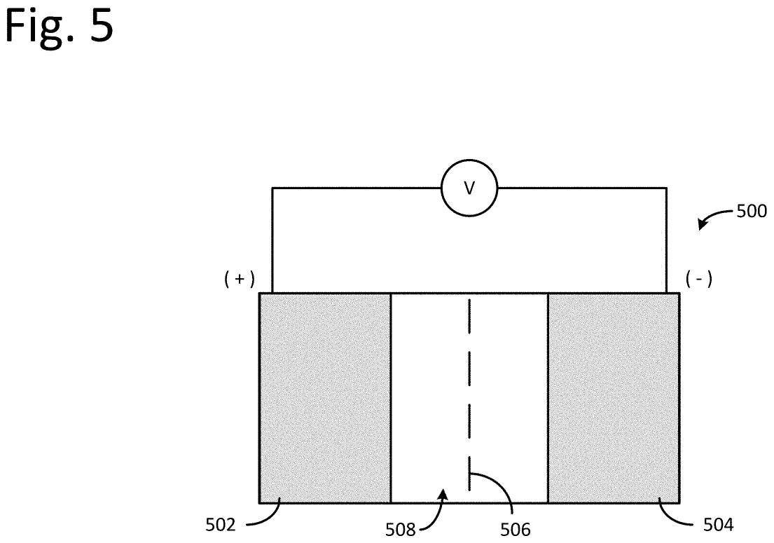

To facilitate the charging the battery 112 using charging cycles as described herein, the charging apparatus 100 may further include the discharger 106. The discharger 106 may be operably coupled to the computing apparatus 108. The discharger 106 may include one or more switches, loads, pulse width modulators (PWM), or other devices for adjusting a resistive load of the discharger 106. The discharger 106 may be operable or controllable (e.g., by the computing apparatus 108) to discharge the battery 112 at any suitable rate. By controlling the resistive load of the discharger 106, the rate of discharge of the battery 112 via the discharger 106 can be adjusted based on a desired rate of discharge of the battery 112. Embodiments of some example circuits that allow the resistive load of the discharger 106 to be adjusted are shown in FIGS. 4 and 5. In one or more embodiments, the charger 104 and discharger 106 may be a combined charger/discharger circuit or device.

Various parameters regarding charging and discharging the battery may be sensed by the sensors 110. The sensors 110 may include any suitable sensors for sensing parameters to determine, for example, a charging current, a discharging current, a temperature of the charger 104, a temperature of the discharger 106, a temperature of the battery 112 or device 102, a charging voltage, a voltage of the battery, a state of charge of the battery, etc. The sensors 110, may be operably coupled to the computing apparatus 108. Additionally, each of the sensors 110 may be configured to provide a signal representative of a sensed parameter (e.g., a charging current, a discharging current, a temperature of the charger 104, a temperature of the discharger 106, a temperature of the battery 112 or device 102, a charging voltage, a voltage of the battery, a state of charge of the battery, etc.) to the computing apparatus 108.

Functionality of the charging apparatus 100 including operation of the charger 104, discharger 106, and sensors 110 may be controlled by the computing apparatus 108. The computing apparatus 108 may be operatively coupled to each of the charger 104, the discharger 106, and the sensors 110. The computing apparatus 108 may be configured to charge the battery 112 using the charger 104. The computing apparatus 108 may further be configured to discharge the battery 112 using the discharger 106. Still further, the computing apparatus 108 may be configured to charge the battery 112 to a predetermined threshold state of charge using a plurality of charge cycles that include charging the battery 112 using the charger 104 and discharging the battery 112 using the discharger 106.

The computing apparatus may be configured to monitor various conditions related to charging the battery 112 or the electrochemical cells 116 such as, e.g., a charging current, a discharging current, a voltage of the battery 112, a temperature (e.g., a temperature of the charger 104, the discharger 106, or the battery 112), a state of charge of the battery 112, etc. Additionally, the computing apparatus 108 may be configured to determine a charge rate, determine a discharge rate, determine a state of charge of the battery 112, determine a charging current of the battery, determine a charging voltage of the battery, compare the state of charge of the battery to one or more thresholds, cause the charger to charge the battery, cause the charger to discharge the battery, etc.

The computing apparatus 108 may be configured to charge the battery 112 using alternating periods of charging and discharging. In one embodiment, the computing apparatus 108 may be configured to charge the battery 112 to a predetermined threshold state of charge using a plurality of charge cycles. Each of the plurality of charge cycles may include charging the battery 112 to increase a state of charge of the battery from an initial-cycle state of charge to an intermediate-cycle state of charge at a charge rate using the charger 104. Each of the plurality of charge cycles may further include discharging the battery 112 to decrease the state of charge of the battery from the intermediate-cycle state of charge to a final-cycle state of charge at a discharge rate faster than the charge rate using the discharger. The increase of the state of charge may be at least twice as much as the decrease of the state of charge.

The predetermined threshold state of charge may be based on a state of charge of the battery 112 from which the battery 112 is charged at a constant voltage to achieve a full charge of the battery 112. The full charge of the battery may depend on the chemistry of the battery 112. The full charge may be, for example, at least 90 percent, 95 percent, 98 percent, or 99 percent of the maximum capacity or state of charge of the battery. In general, rechargeable batteries may be charged using a constant current or a constant voltage. Rechargeable batteries may be charged using a constant current until a maximum charging voltage threshold is reached. During constant current charging the voltage may be increased as the state of charge and voltage of the battery 112 increases to maintain the constant current. Once the maximum charging voltage threshold is reached, the charging voltage may not be increased further resulting in the charging current changing. The charging current may change because a voltage difference between the maximum charging voltage and the voltage of the battery 112 will decrease as the battery 112 continues to charge and the voltage of the battery increases. Accordingly, the predetermined threshold state of charge may be less than or equal to a state of charge of the battery 112 that corresponds to a maximum charging voltage of the battery.

Before beginning any of the charge cycles to charge the battery 112 to the predetermined threshold state of charge, the computing apparatus 108 may compare a current state of charge of the battery 112 to the predetermined threshold state of charge. The current state of charge of the battery 112 may be determined using one of the sensors 110. For example, a voltage of the battery 112 may be sensed by one of the sensors 110 and the computing apparatus 108 may determine the state of charge of the battery 112 based on the sensed voltage and a state of charge of the battery 112 that corresponds to the sensed voltage. Determining the state of charge of the battery 112 based on the sensed voltage may include using a lookup table stored in memory, using one or more equations or mathematical steps, interpolation, etc. The current state of charge of the battery 112 may be determined based on the final-cycle state of charge of a most recent charge cycle to charge the battery 112 to the predetermined threshold state of charge. The final-cycle state of charge may be the state of charge of the battery 112 when a given charge cycle is completed. The computing apparatus 108 may be configured to charge the battery 112 using another charge cycle in response to the current state of charge of the battery 112 being less than the predetermined state of charge.

The computing apparatus 108 may be configured to charge the battery 112 at the same charge rate for each charge cycle. Alternatively, the computing apparatus 108 may be configured to charge the battery 112 at a different charge rate for at least one of the charge cycles. In one embodiment, the computing apparatus 108 may be configured to charge the battery 112 at a charge rate for a given charge cycle based on the initial-cycle state of charge of the battery 112 of the given charge cycle. The initial-cycle state of charge may be the current state of charge of the battery 112 or the final-cycle state of charge of the most recent charge cycle. When the given charge cycle is a second charge cycle or greater of the charge cycles used to charge the battery 112 to the predetermined threshold state of charge, the final-cycle state of charge of the most recent charge cycle may be equal to the current state of charge of the battery.

In another embodiment, the computing apparatus 108 may be configured to charge the battery 112 at a charge rate for the given charge cycle based on a number of charge cycles that have been completed. For example, the charge rate of a first charge cycle may be greater than the charge rate of a last charge cycle when charging the battery to the predetermined threshold state of charge. In another example, the rate of charge of each charge cycle may be less than the rate of charge of the most recent charge cycle.

The battery 112 may include the BMS 114 to monitor the electrochemical cells 116, maintain safe operating conditions of the electrochemical cells, report various conditions of the electrochemical cells, etc. Additionally, the BMS 114 may be configured to charge the battery 112 including charging the battery 112 to a predetermined threshold state of charge using a plurality of charge cycles. That is, the BMS 114 may comprise computing apparatus (not shown) to carry out one or more aspects described herein regarding computing apparatus 108.

The BMS 114 may be operably couplable to each of the charger 104, the discharger 106. The BMS 114 may be configured to charge the battery 112 using the charger 104. The BMS 114 may further be configured to discharge the battery 112 using the discharger 106. Still further, the BMS 114 may be configured to charge the battery 112 to a predetermined threshold state of charge using a plurality of charge cycles that include charging the battery 112 using the charger 104 and discharging the battery 112 using the discharger 106.

The computing apparatus may be configured to monitor various conditions related to charging the battery 112 or the electrochemical cells 116 such as, e.g., a charging current, a discharging current, a voltage of the battery 112, a temperature (e.g., a temperature of the charger 104, the discharger 106, or the battery 112), a state of charge of the battery 112, etc. Additionally, the BMS 114 may be configured to determine a charge rate, determine a discharge rate, determine a state of charge of the battery 112, determine a charging current of the battery, determine a charging voltage of the battery, compare the state of charge of the battery to one or more thresholds, cause the charger 104 to charge the battery, cause the charger 104 to discharge the battery, etc.

The BMS 114 may be configured to charge the battery 112 using alternating periods of charging and discharging. In one embodiment, the BMS 114 may be configured to charge the battery 112 to a predetermined threshold state of charge using a plurality of charge cycles. Each of the plurality of charge cycles may include charging the battery 112 to increase a state of charge of the battery from an initial-cycle state of charge to an intermediate-cycle state of charge at a charge rate using the charger 104. Each of the plurality of charge cycles may further include discharging the battery 112 to decrease the state of charge of the battery from the intermediate-cycle state of charge to a final-cycle state of charge at a discharge rate faster than the charge rate using the discharger. The increase of the state of charge may be at least twice as much as the decrease of the state of charge.

The predetermined threshold state of charge may be based on a state of charge of the battery 112 from which the battery 112 is charged at a constant voltage to achieve a full charge of the battery 112. The full charge of the battery may depend on the chemistry of the battery 112. The full charge may be, for example, at least 90 percent, 95 percent, 98 percent, or 99 percent of the maximum capacity or state of charge of the battery. In general, rechargeable batteries may be charged using a constant current or a constant voltage. Rechargeable batteries may be charged using a constant current until a maximum charging voltage threshold is reached. During constant current charging the voltage may be increased as the state of charge and voltage of the battery 112 increases to maintain the constant current. Once the maximum charging voltage threshold is reached, the charging voltage may not be increased further resulting in the charging current changing. The charging current may change because a voltage difference between the maximum charging voltage and the voltage of the battery 112 will decrease as the battery 112 continues to charge and the voltage of the battery increases. Accordingly, the predetermined threshold state of charge may be less than or equal to a state of charge of the battery 112 that corresponds to a maximum charging voltage of the battery.

Before beginning any of the charge cycles to charge the battery 112 to the predetermined threshold state of charge, the computing apparatus 108 may compare a current state of charge of the battery 112 to the predetermined threshold state of charge. The current state of charge of the battery 112 may be determined using one of the sensors 110. For example, a voltage of the battery 112 may be sensed by one of the sensors 110 and the BMS 114 may determine the state of charge of the battery 112 based on the sensed voltage and a state of charge of the battery 112 that corresponds to the sensed voltage. Determining the state of charge of the battery 112 based on the sensed voltage may include using a lookup table stored in memory, using one or more equations or mathematical steps, interpolation, etc. The current state of charge of the battery 112 may be determined based on the final-cycle state of charge of a most recent charge cycle to charge the battery 112 to the predetermined threshold state of charge. The final-cycle state of charge may be the state of charge of the battery 112 when a given charge cycle is completed. The BMS 114 may be configured to charge the battery 112 using another charge cycle in response to the current state of charge of the battery 112 being less than the predetermined state of charge.

The BMS 114 may be configured to charge the battery 112 at the same charge rate for each charge cycle. Alternatively, the BMS 114 may be configured to charge the battery 112 at a different charge rate for at least one of the charge cycles. In one embodiment, the BMS 114 may be configured to charge the battery 112 at a charge rate for a given charge cycle based on the initial-cycle state of charge of the battery 112 of the given charge cycle. The initial-cycle state of charge may be the current state of charge of the battery 112 or the final-cycle state of charge of the most recent charge cycle. When the given charge cycle is a second charge cycle or greater of the charge cycles used to charge the battery 112 to the predetermined threshold state of charge, the final-cycle state of charge of the most recent charge cycle may be equal to the current state of charge of the battery.

In another embodiment, the BMS 114 may be configured to charge the battery 112 at a charge rate for the given charge cycle based on a number of charge cycles that have been completed. For example, the charge rate of a first charge cycle may be greater than the charge rate of a last charge cycle when charging the battery to the predetermined threshold state of charge. In another example, the rate of charge of each charge cycle may be less than the rate of charge of the most recent charge cycle.

The battery 112 may further include sensors 118 to sense temperature, voltage, current, etc. The sensors 118 may include any suitable sensor or sensors such as, e.g., temperature sensors, current sensors, voltage sensors, state of charge sensors, etc. The sensors 118 may provide a sensed temperature signal, sensed current signal, sensed voltage signal, sensed state of charge signal, etc. The signals provided by the sensors 118 may be indicative of the properties sensed by the sensors.

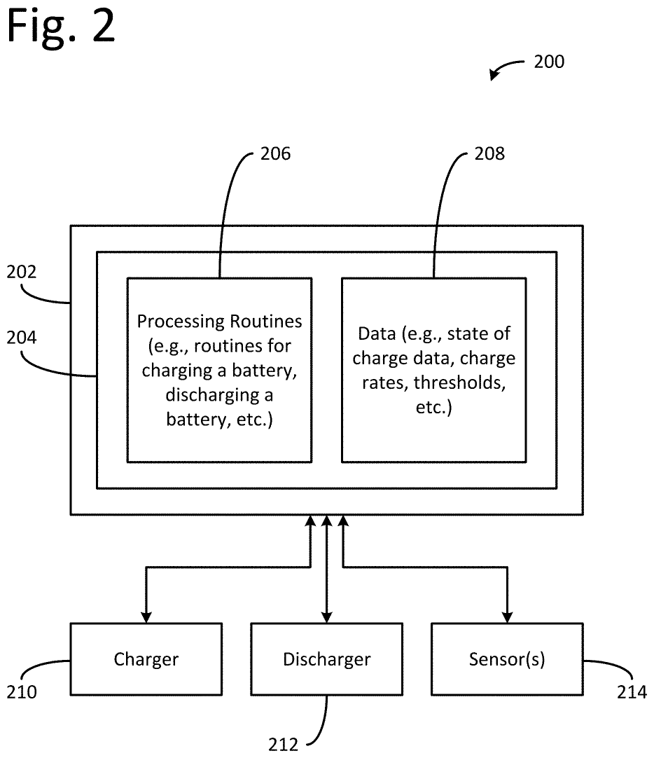

A schematic block diagram of a charging apparatus 200 (e.g., charging apparatus 100 of FIG. 1) according to embodiments described herein is shown in FIG. 2. The charging apparatus 200 may include a computing apparatus or processor 202, a charger 210. Generally, the charger 210 may be operably coupled to the computing apparatus 202 and may include any suitable circuits or devices configured charge batteries or electrochemical cells. For example, the charger 210 may include one or more power sources, rectifier circuits, power circuits, control circuits, regulator circuits, fault detection circuits, etc.

The charging apparatus 200 may additionally include a discharger 212 operably coupled to the computing apparatus 202. Generally, the discharger 212 may include any one or more devices configured to discharge batteries or electrochemical cells. For example, the discharger 212 may include one or more loads, switches, switching networks, pulse width modulators, etc.

The charging apparatus 200 may still further include one or more sensors 214 operably coupled to the computing apparatus 202. Generally, the sensors 214 may include any one or more devices configured to sense charging information of the charger 210 or electrochemical cells. The sensors 214 may include any apparatus, structure, or device to capture the charging information of the charger such as one or more current sensors, voltage sensors, temperature sensors, etc.

Further, the computing apparatus 202 includes data storage 204. Data storage 204 allows for access to processing programs or routines 206 and one or more other types of data 208 that may be employed to carry out the techniques, processes, and algorithms for charging a battery or one or more electrochemical cells. For example, processing programs or routines 206 may include programs or routines for charging a battery to a predetermined threshold state of charge, determining a charging current, determining a charging voltage, charging a battery, determining a rate of charge, determining a rate of discharge, determining a threshold state of charge, determining a charge resistance at a current state of charge, determining a discharge resistance at a current state of charge, computational mathematics, matrix mathematics, Fourier transforms, compression algorithms, calibration algorithms, image construction algorithms, inversion algorithms, signal processing algorithms, normalizing algorithms, deconvolution algorithms, averaging algorithms, standardization algorithms, comparison algorithms, vector mathematics, or any other processing required to implement one or more embodiments as described herein.

Data 208 may include, for example, state of charge data, charge rate data, discharge rate data, charging current data, charging voltage data, temperature data, voltage data, charging current data, state of health data, resistance calculations, device settings, error bit states, historical data, thresholds, arrays, meshes, grids, variables, counters, statistical estimations of accuracy of results, results from one or more processing programs or routines employed according to the disclosure herein (e.g., charging a battery, discharging a battery, etc.), or any other data that may be necessary for carrying out the one or more processes or techniques described herein.

In one or more embodiments, the charging apparatus 200 may be controlled using one or more computer programs executed on programmable computers, such as computers that include, for example, processing capabilities (e.g., microcontrollers, programmable logic devices, etc.), data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

The programs used to implement the processes described herein may be provided using any programmable language, e.g., a high-level procedural and/or object orientated programming language that is suitable for communicating with a computer system. Any such programs may, for example, be stored on any suitable device, e.g., a storage media, readable by a general or special purpose program, computer or a processor apparatus for configuring and operating the computer when the suitable device is read for performing the procedures described herein. In other words, at least in one embodiment, the charging apparatus 200 may be controlled using a computer readable storage medium, configured with a computer program, where the storage medium so configured causes the computer to operate in a specific and predefined manner to perform functions described herein.

The computing apparatus 202 may be, for example, any fixed or mobile computer system (e.g., a personal computer or minicomputer). The exact configuration of the computing apparatus is not limiting and essentially any device capable of providing suitable computing capabilities and control capabilities (e.g., control the power output of the charging apparatus 200, the acquisition of data, such as sensor data) may be used. Additionally, the computing apparatus 202 may be incorporated in a housing of the charging apparatus 200. Further, various peripheral devices, such as a computer display, mouse, keyboard, memory, printer, scanner, etc. are contemplated to be used in combination with the computing apparatus 202. Further, in one or more embodiments, the data 208 (e.g., state of charge data, charge rate data, discharge rate data, charging current data, charging voltage data, temperature data, voltage data, charging current data, state of health data, etc.) may be analyzed by a user, used by another machine that provides output based thereon, etc. As described herein, a digital file may be any medium (e.g., volatile or non-volatile memory, a CD-ROM, a punch card, magnetic recordable tape, etc.) containing digital bits (e.g., encoded in binary, trinary, etc.) that may be readable and/or writeable by computing apparatus 202 described herein. Also, as described herein, a file in user-readable format may be any representation of data (e.g., ASCII text, binary numbers, hexadecimal numbers, decimal numbers, audio, graphical) presentable on any medium (e.g., paper, a display, sound waves, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware that is to be used to implement the processes described herein shall not be limiting on the scope of the systems, processes or programs (e.g., the functionality provided by such systems, processes or programs) described herein.

The techniques described in this disclosure, including those attributed to the systems, or various constituent components, may be implemented, at least in part, in hardware, software, firmware, or any combination thereof. For example, various aspects of the techniques may be implemented by the computing apparatus 202, which may use one or more processors such as, e.g., one or more microprocessors, DSPs, ASICs, FPGAs, CPLDs, microcontrollers, or any other equivalent integrated or discrete logic circuitry, as well as any combinations of such components, image processing devices, or other devices. The term “processing apparatus,” “processor,” or “processing circuitry” may generally refer to any of the foregoing logic circuitry, alone or in combination with other logic circuitry, or any other equivalent circuitry. Additionally, the use of the word “processor” may not be limited to the use of a single processor but is intended to connote that at least one processor may be used to perform the techniques and processes described herein.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, magnetic data storage media, optical data storage media, or the like. The instructions may be executed by the computing apparatus 202 to support one or more aspects of the functionality described in this disclosure.

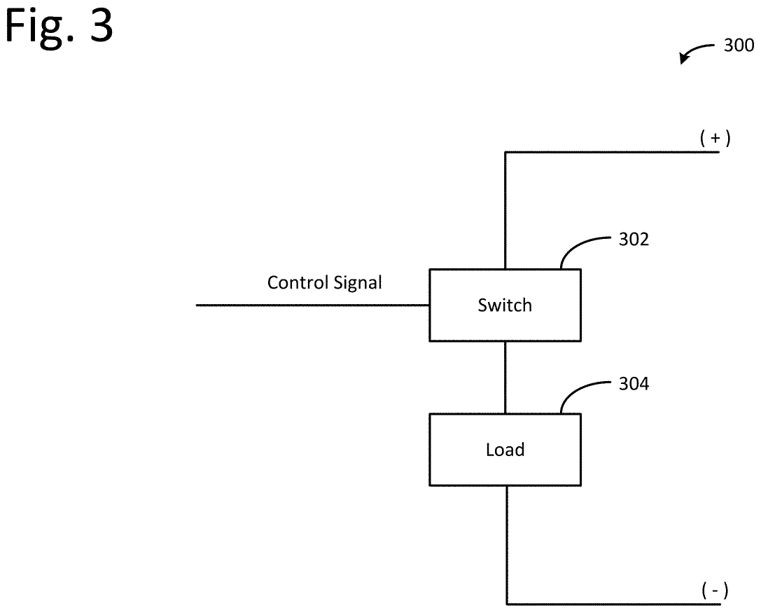

FIGS. 3 and 4 show embodiments of circuitry that may be included in a discharger as described herein (e.g., the discharger 106 of FIG. 1 or the discharger 212 of FIG. 2.). FIG. 3 shows a discharger 300 that includes a switch 302 and a load 304. FIG. 4 shows a switching network 400 that may be included in a discharger as described herein.

The switch 302 of the discharger 300 may be operably coupled to a computing apparatus (e.g., computing apparatus 108 of FIG. 1 or computing apparatus 202 of FIG. 2) and the load 304. The switch 302 may be operably coupled to the load 304 in series. The series arrangement of the switch 302 and the load 304 may allow the switch 302 and the load 304 to be operably couplable to a battery (e.g., battery 112 of FIG. 1) such that the switch can allow or prevent discharge of the battery through the load 304. The switch 302 may be configured to selectively allow discharge of one or more batteries through the load 304. The switch 302 may be configured to receive a control signal from a computing apparatus to toggle between an open and a close position. When the switch 302 is in the opened, no current may flow to the load 304 from an operably coupled battery. Accordingly, when the switch 302 is opened, the discharger 300 cannot not discharge any operable coupled batteries. When the switch 302 is closed, current may flow to the load 304 from an operably coupled battery. Accordingly, when the switch 302 is closed, the discharger 300 can discharge any operably coupled battery.

The switch 302 may include one or more devices or circuits that allow a current path to the load 304 to be open or closed by a computing apparatus. The switch 302 may include, for example, one or more transistors or pulse width modulators. In one embodiment, the switch 302 includes a pulse width modulator. The pulse width modulator may be configured to operate at a duty cycle based on a received control signal (e.g., from a computing apparatus). The switch 302 may be configured to operate at a duty cycle during discharge. The duty cycle may be based on a direct current (DC) resistance of the load 304 and the discharge rate. The load 304 may provide a static or unchanging DC resistance. Accordingly, if the switch 302 remains closed (e.g., 100 percent duty cycle) during discharge, the discharge rate may be a maximum discharge rate based on a voltage of the battery and the DC resistance of the load 304 that cannot be adjusted. However, by operating the switch 302 at a duty cycle, any percentage of the maximum discharge rate can be achieved.

The load 304 may include any one or more devices to provide a DC resistance.

The load 304 may also include one or more devices to store and/or dissipate heat generated by discharge of a battery through the load 304. The load may include one or more resistors arranged in any suitable series and/or parallel configuration to achieve a desired DC resistance. Although the load 304 of the discharger 300 is a static load, dischargers may also include multiple static loads one or more devices and/or circuits to provide an adaptive load that can be adjusted by a computing device.

The switching network 400 of FIG. 4 may be capable of providing an adaptive or adjustable load in a discharger. As shown, the switching network 400 includes switches SW1-SW12 and loads R1-R3. Although the loads R1-R3 are static loads, the switches SW1-SW12 can be opened or closed to adjust the resistive load of a discharger (e.g., the load seen by the battery during discharge). The switches SW1-SW12 may be configured to selectively allow discharge of the one or more batteries through one or more of the loads R1-R3. By closing switches SW1-SW12 in various configurations, the loads R1-R3 can be arranged in various combinations that include series and/or parallel arrangements of the loads R1-R3. A non-exhaustive list of various combinations that can be provided by the switching network 400 are shown in Table 1.

TABLE 1

| Load | Closed Switches |
|---|---|
| R1 | SW1 and SW10 |
| R2 | SW2 and SW11 |
| R3 | SW3 and SW12 |
| R1 + R2 | S1, SW6, and SW11 |
| R1 + R3 | SW1, SW4, and SW12 |
| R2 + R3 | SW2, SW9, and SW12 |
| R1 + R2 + R3 | SW1, SW6, SW9, and SW12 |
| R1 ∥ R2 | SW1, SW2, SW10, and SW11 |
| R1 ∥ R3 | S1, SW3, SW10, and SW12 |
| R2 ∥ R3 | SW2, SW3, SW11, and SW12 |
| R1 ∥ R2 ∥ R3 | SW1, S2, S3, S10, SW11, SW12 |
| (R1 + R2) ∥ R3 | SW1, SW3, SW6, SW11, SW12 |
| (R1 + R3) ∥ R2 | SW1, SW2, SW4, SW11, and SW12 |
| (R2 + R3) ∥ R1 | S1, SW2, SW9, SW10, and SW12 |
| (R1 ∥ R2) + R3 | SW3, SW5, SW7, SW10, and SW11 |
| (R1 ∥ R3) + R2 | SW2, SW8, SW9, SW10, and SW12 |
| (R2 ∥ R3) + R1 | SW1, SW4, SW6, SW11, SW12 |

As shown in table 1, the switches SW1-SW12 can be closed to provide any series and/or parallel combination of the loads R1-R3. Accordingly, a wide range of DC resistance can be provided even without operating switches at a duty cycle. For example, using resistive loads of 1 Ohm for R1, 10 Ohms for R2, and 100 Ohms for R3 and a battery voltage of 4 volts, total resistances between 0.9 Ohms and 111 Ohms discharge currents between 4 milliamps and 4.44 amps can be achieved as shown in Table 2.

TABLE 2

| Load Combination | Resistance | Current |
|---|---|---|
| (R1 ∥ R2) + R3 | 0.90 | 4.44 |
| (R1 ∥ R3) + R2 | 0.90 | 4.44 |
| (R2 ∥ R3) + R1 | 0.90 | 4.44 |
| R1 ∥ R2 | 0.91 | 4.40 |
| R1 ∥ R2 ∥ R3 | 0.91 | 4.40 |
| R1 ∥ R3 | 0.99 | 4.04 |
| (R2 + R3) ∥ R1 | 0.99 | 4.04 |
| R1 | 1.00 | 4.00 |
| R2 ∥ R3 | 9.09 | 0.44 |
| (R1 + R3) ∥ R2 | 9.10 | 0.44 |
| (R1 + R2) ∥ R3 | 9.91 | 0.40 |
| R2 | 10.00 | 0.40 |
| R1 + R2 | 11.00 | 0.36 |
| R3 | 100.00 | 0.04 |
| R1 + R3 | 101.00 | 0.04 |
| R2 + R3 | 110.00 | 0.04 |
| R1 + R2 + R3 | 111.00 | 0.04 |

One of skill in the art will appreciate that different DC resistances and additional loads can provide additional discrete total resistances across a variety of ranges depending on the discharge rates desired for a given battery. Additionally, duty cycling can be used in conjunction with the switching network 400 to provide almost any desired discharge rate. Accordingly, discharge circuits as described herein can provide suitable discharge rates for any battery or electrochemical cell type.

A schematic representation of a portion of a lithium electrochemical cell 500 is shown (e.g., electrochemical cells 116 of FIG. 1) in FIG. 5. The electrochemical cell 500 includes a positive electrode 502, a negative electrode 504, an electrolyte material 508, and a separator (e.g., a polymeric microporous separator) 506 provided intermediate or between the positive electrode 502 and the negative electrode 504. The electrodes 502, 504 may be provided as relatively flat or planar plates or may be wrapped or wound in a spiral or other configuration (e.g., an oval configuration). The electrode may also be provided in a folded configuration.

During charging and discharging of the electrochemical cell 500, lithium ions move between the positive electrode 502 and the negative electrode 504. For example, when the electrochemical cell 500 is discharged, lithium ions flow from the negative electrode 504 to the positive electrode 502. In contrast, when the electrochemical cell 500 is charged, lithium ions flow from the positive electrode 502 to the negative electrode 504.

The electrochemical cell 500 may be any suitable rechargeable electrochemical cell type. While the charging methods and systems described herein may result in improved lithium plating topography for lithium metal batteries, other battery types may be charged using such charging methods and systems. For example, the electrochemical cell 500 may be a lithium-ion electrochemical cell, a lithium metal electrochemical cell, a lithium polymer electrochemical cell, or other rechargeable electrochemical cell. Accordingly, the batteries described herein may be, for example, lithium-ion batteries, lithium metal batteries, lithium polymer batteries, or other rechargeable batteries. In at least one embodiment, the electrochemical cell 500 is a lithium metal electrochemical cell. In one embodiment, the batteries described herein are lithium metal batteries.

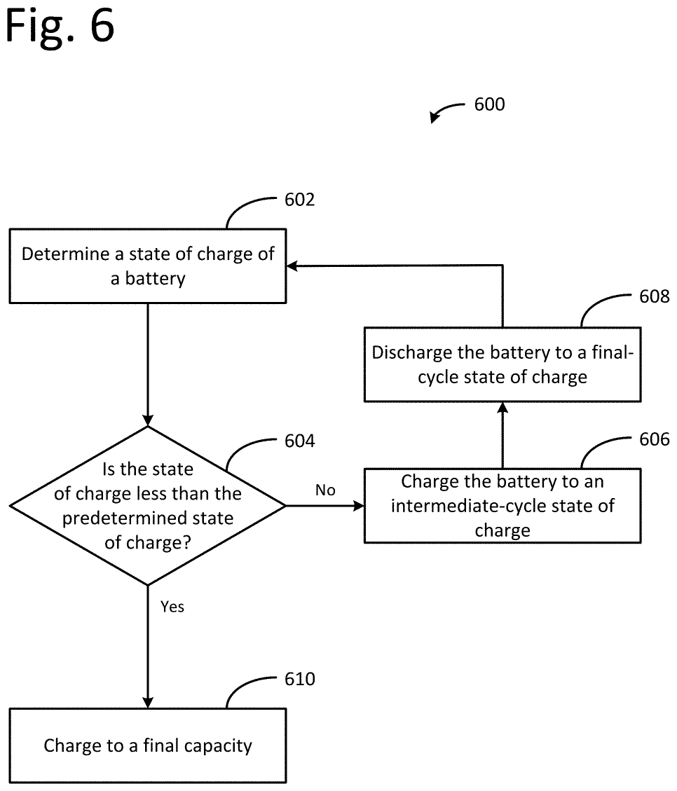

A method or process 600 of charging a battery or electrochemical cell (e.g., battery 112 or electrochemical cells 116 of FIG. 1 or electrochemical cell 500 of FIG. 5) is shown in FIG. 6.

The method 600 may include determining a state of charge of a battery (e.g., battery 112) 602. Determining the state of charge of the battery may be based on a current state of charge of the battery or a final-cycle state of charge of a most recent charge cycle. The current state of charge of the battery may be determined based on one or more parameters (e.g., voltage, maximum capacity, etc.) of the battery sensed by one or more sensors (e.g., sensors 110 or 118 of FIG. 1). The current state of charge of the battery may be determined when the charging process 600 has just begun and the battery has not been through a charge cycle. In contrast, the state of charge of the battery may be equal to the final-cycle state of charge of the most recent charge cycle after the battery has been charged using at least one charge cycle.

The method 600 may further include comparing the state of charge of the battery to a predetermined threshold state of charge 604. The predetermined threshold state of charge may be based on a state of charge of the battery from which the battery is charged at a constant voltage to achieve a full charge of the battery. The full charge of the battery may depend on the chemistry of the battery. The full charge may be, for example, at least 90 percent, 95 percent, 98 percent, or 99 percent of the maximum capacity or state of charge of the battery. In general, rechargeable batteries may be charged using a constant current or a constant voltage. Rechargeable batteries may be charged using a constant current until a maximum charging voltage threshold is reached. During constant current charging the voltage may be increased as the state of charge and voltage of the battery increases to maintain the constant current. Once the maximum charging voltage threshold is reached, the charging voltage may not be increased further resulting in the charging current changing. The charging current may change because a voltage difference between the maximum charging voltage and the voltage of the battery will decrease as the battery continues to charge and the voltage of the battery increases. Accordingly, the predetermined threshold state of charge may be less than or equal to a state of charge of the battery that corresponds to a maximum charging voltage of the battery.

If the state of charge of the battery is not equal to or greater than the predetermined threshold state of charge, the battery may be charged to the predetermined threshold state of charge using a plurality of charge cycles. Each of the plurality of charge cycles includes charging the battery to increase a state of charge of the battery from an initial-cycle state of charge to an intermediate-cycle state of charge at a charge rate 606 and discharging the battery to decrease the state of charge of the battery from the intermediate-cycle state of charge to a final-cycle state of charge at a discharge rate faster than the charge rate, wherein the increase of the state of charge is at least twice as much as the decrease of the state of charge 608.

The charge rate may be at least 0.1C and no greater than 5C or for any suitable range in between. For example, the charge rate may be in a range from at least 0.1C, 0.25C, 0.5C, 0.75C, or 1C to no greater than 1.5 C, 2C, 3C, 4C, or 5C. In at least one embodiment, the charge rate may be at least 0.5C and no greater than 2C. The charge rate of a given charge cycle may vary from charge cycle to charge cycle. In one embodiment, the charge rate of a first charge cycle of the plurality of charge cycles may be greater than the charge rate of a last charge cycle of the plurality of charge cycles. In at least one embodiment, each of the plurality of charge cycles further includes determining the initial-cycle state of charge based on a current state of charge of the battery or the final-cycle state of charge of a most recent charge cycle and determining the charge rate based on the initial-cycle state of charge.

The increase of the state of charge may be at least 10 percent of a maximum capacity of the battery and no greater than 40 percent of the maximum capacity of the battery or any suitable range therebetween. For example, the increase of the state of charge may be in a range from at least 10 percent, 15 percent, 20 percent, or 25 percent of the maximum capacity of the battery to no greater than 25 percent, 30 percent, 35 percent, or 40 percent of the maximum capacity of the battery. The increase of the state of charge of a given charge cycle may also vary from charge cycle to charge cycle. In one embodiment, the increase of the state of charge of a charge cycle of the plurality of charge cycles is greater than the increase of the state of charge of another charge cycle of the plurality of charge cycles. A difference between the charge rate of any one of the charge cycles of the plurality of charge cycles and any other of the charge cycles of the plurality of charge cycles may be less than 0.5C.

Discharging of the battery during each charge cycle may be based on a charge rate of the charge cycle and an increase in the state of charge of the battery during the charging step of the charge cycle. The discharge rate of the charge cycle may be at least 2 times as fast as the charge rate and no greater than 10 times as fast as the charge rate or any suitable range therebetween. For example, the discharge rate of the charge cycle may be in a range of at least 2 times, 3 times, 4 times, 5 times, or 6 times faster than the charge rate and no greater than 7 times, 8 times, 9 times, or 10 times faster than the charge rate. In one embodiment, the discharge rate of the charge cycle is at least twice as fast as the charge rate. The discharge rate may be at least 0.5C and no greater than 20C or any suitable range therebetween. For example, the discharge rate may be in a range from at least 0.5C, 1C, 1.5C, 2C, 3C, 4C, or 5C to no greater than 6C, 8C, 10C, 12C, 14C, 16C, 18C, or 20C. In at least one embodiment, the discharge rate is at least 1C and no greater than 10C.

The decrease of the state of charge of the battery 112 may be less than or equal to half as much as the increase of the state of charge during the charge cycle. In other words, the increase of the state of charge is at least twice as much as the decrease of the state of charge of each charge cycle. In still other words, the capacity charged in a charge cycle at least twice as much as the capacity discharged in the same charge cycle. Accordingly, the final-cycle state of charge of a charge cycle is always greater than the initial-cycle state of charge of the same charge cycle. The increase of the state of charge of a charge cycle may be at least 2 times as much to no greater than 10 times as much as the decrease of the state of charge in the same charge cycle. The increase of the state of charge of a charge cycle may be at least 2 times, 3 times, 4 times, 5 times, or 6 times as much to no greater than 7 times, 8 times, 9 times, or 10 times as much as the decrease of the state of charge in the same charge cycle.

Accordingly, the decrease of the state of charge may be no greater than 20 percent of the maximum capacity of the battery. For example, the decrease of the state of charge may be no greater than 20 percent, 15 percent, 10 percent, or 5 percent of the maximum capacity of the battery. The decrease of the state of charge of a given charge cycle may also vary from charge cycle to charge cycle. In one embodiment, the decrease of the state of charge of a charge cycle of the plurality of charge cycles is greater than the decrease of the state of charge of another charge cycle of the plurality of charge cycles.

The method 600 may further include charging the battery to a final capacity 610. Charging the battery to the final capacity (e.g., fully charged) may include charging the battery using constant voltage charging in response to the final-cycle state of charge of a most recent charge cycle of the plurality of charge cycles being equal to or greater than the predetermined threshold state of charge. The predetermined threshold state of charge may be within 5 percent state of charge of the state of charge of the battery corresponding to the maximum charge voltage threshold. Accordingly, the battery may be charged continuously using constant voltage charging until the battery is fully charged. Alternatively, the final capacity may be the predetermined threshold state of charge.

The invention is defined in the claims. However, below there is provided a non-exhaustive list of non-limiting examples. Any one or more of the features of these examples may be combined with any one or more features of another example, embodiment, or aspect described herein.

Example Ex1: A method of charging a battery comprising charging a battery to a predetermined threshold state of charge using a plurality of charge cycles, each of the plurality of charge cycles comprising: charging the battery to increase a state of charge of the battery from an initial-cycle state of charge to an intermediate-cycle state of charge at a charge rate; and discharging the battery to decrease the state of charge of the battery from the intermediate-cycle state of charge to a final-cycle state of charge at a discharge rate faster than the charge rate, wherein the increase of the state of charge is at least twice as much as the decrease of the state of charge.

Example Ex2: The method of example Ex1, wherein the method of charging the battery further comprises comparing the final-cycle state of a most recent charge cycle of the plurality of charge cycles to the predetermined state of charge; and charging the battery using another charge cycle of the plurality of charge cycles in response to the final-cycle state of charge of the most recent charge cycle being less than the predetermined state of charge.

Example Ex3: The method of example Ex1, wherein the charge rate of a first charge cycle of the plurality of charge cycles is greater than the charge rate of a last charge cycle of the plurality of charge cycles.

Example Ex4: The method of example Ex1, wherein each of the plurality of charge cycles further comprises determining the initial-cycle state of charge based on a current state of charge of the battery or the final-cycle state of charge of a most recent charge cycle; and determining the charge rate based on the initial-cycle state of charge.

Example Ex5: The method of example Ex1, wherein the discharge rate is at least twice as fast as the charge rate.

Example Ex6: The method of example Ex1, wherein the increase of the state of charge is at least 10 percent of a maximum capacity of the battery and no greater than 40 percent of the maximum capacity of the battery.

Example Ex7: The method of example Ex1, wherein the increase of the state of charge of a charge cycle of the plurality of charge cycles is greater than the increase of the state of charge of another charge cycle of the plurality of charge cycles.

Example Ex8: The method of example Ex1, further comprising charging the battery using constant voltage charging in response to the final-cycle state of charge of a most recent charge cycle of the plurality of charge cycles being equal to or greater than the predetermined threshold state of charge.

Example Ex9: The method of example Ex1, wherein a difference between the charge rate of any one of the plurality of charge cycles and any other of the plurality of charge cycles is less than 0.5C.

Example Ex10: A battery charging apparatus comprising a charger to charge one or more batteries; a discharger to discharge the one or more batteries; and a computing apparatus comprising one or more processors operably coupled to the charger and the discharger and configured to charge a battery to a predetermined threshold state of charge using a plurality of charge cycles, each of the plurality of charge cycles comprising charging the one or more batteries to increase a state of charge of the battery from an initial-cycle state of charge to an intermediate-cycle state of charge at a charge rate using the charger; and discharging the one or more batteries to decrease the state of charge of the battery from the intermediate-cycle state of charge to a final-cycle state of charge at a discharge rate faster than the charge rate using the discharger, wherein the increase of the state of charge is at least twice as much as the decrease of the state of charge.

Example Ex11: The apparatus of example Ex10, wherein the discharger comprises: a load; and a switch operatively coupled to the load and the computing apparatus to selectively allow discharge of the one or more batteries through the load; wherein the computing apparatus is configured to operate the switch at a duty cycle during discharge of the one or more batteries, the duty cycle based on a resistance of the load and the discharge rate.

Example Ex12: The apparatus of example Ex11, wherein the switch includes a pulse width modulator.

Example Ex13: The apparatus of example Ex10, wherein the discharger comprises a plurality of loads; and a switching network comprising a plurality of switches, the switching network operatively coupled to the plurality of loads and the computing apparatus and configured to selectively allow discharge of the one or more batteries through one or more of the plurality of loads; wherein the computing apparatus is further configured to operate the switch network during discharge based on a resistance of each of the plurality of loads and the discharge rate.

Example Ex14: The apparatus of example Ex10, wherein to charge the battery to the predetermined threshold state of charge the computing apparatus is further configured to compare the final-cycle state of a most recent charge cycle of the plurality of charge cycles to the predetermined state of charge; and charge the one or more batteries using another charge cycle of the plurality of charge cycles in response to the final-cycle state of charge of the most recent charge cycle being less than the predetermined state of charge.

Example Ex15: The apparatus of example Ex10, wherein the charge rate of a first charge cycle of the plurality of charge cycles is greater than the charge rate of a last charge cycle of the plurality of charge cycles.

Example Ex16: The apparatus of example Ex10, wherein each of the plurality of charge cycles further comprises determining the initial-cycle state of charge based on a current state of charge of the one or more batteries or the final-cycle state of charge of a most recent charge cycle; and determining the charge rate based on the initial-cycle state of charge.

Example Ex17: The apparatus of example Ex10, wherein the discharge rate is at least twice as fast as the charge rate.

Example Ex18: A system comprising: a charging apparatus for charging one or more batteries; a discharge apparatus for discharging the one or more batteries; and a battery operatively coupled to the charging apparatus, the battery comprising one or more electrochemical cells; and a battery management system comprising one or more processors operably coupled to the one or more electrochemical cells and configured to charge the battery to a predetermined threshold state of charge using a plurality of charge cycles, each of the plurality of charge cycles comprising: charging the battery to increase a state of charge of the battery from an initial-cycle state of charge to an intermediate-cycle state of charge at a charge rate; and discharging the battery to decrease the state of charge of the battery from the intermediate-cycle state of charge to a final-cycle state of charge at a discharge rate faster than the charge rate, wherein the increase of the state of charge is at least twice as much as the decrease of the state of charge.

Example Ex19: The system of example Ex18, wherein the discharger comprises: a load; and a switch operatively coupled to the load and the battery management system to selectively allow discharge of the battery through the load; wherein the battery management system is configured to operate the switch at a duty cycle during discharge of the battery, the duty cycle based on a resistance of the load and the discharge rate.

Example Ex20: The system of example Ex18, wherein the discharger comprises: a plurality of loads; and a switching network comprising a plurality of switches, the switching network operatively coupled to the plurality of loads and the battery management system and configured to selectively allow discharge of the battery through one or more of the plurality of loads; wherein the battery management system is further configured to operate the switch network during discharge based on a resistance of each of the plurality of loads and the discharge rate.

Example Ex21: The system of example Ex18, wherein to charge the battery to the predetermined threshold state of charge the battery management system is further configured to: compare the final-cycle state of a most recent charge cycle of the plurality of charge cycles to the predetermined state of charge; and charge the battery using another charge cycle of the plurality of charge cycles in response to the final-cycle state of charge of the most recent charge cycle being less than the predetermined state of charge.

Example Ex22: The system of example Ex18, wherein the discharge rate is at least twice as fast as the charge rate.

Example Ex23: The system of example Ex18, wherein each of the plurality of charge cycles further comprises determining the initial-cycle state of charge based on a current state of charge of the battery or the final-cycle state of charge of a most recent charge cycle; and determining the charge rate based on the initial-cycle state of charge.

Example Ex24: The system of example Ex18, wherein the battery one or more electrochemical cells are lithium metal electrochemical cells.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

What is claimed is:

1. A method of charging a battery comprising:
charging a battery to a predetermined threshold state of charge using a plurality of charge cycles, each of the plurality of charge cycles comprising:
charging the battery to increase a state of charge of the battery from an initial-cycle state of charge to an intermediate-cycle state of charge at a charge rate; and
discharging the battery to decrease the state of charge of the battery from the intermediate-cycle state of charge to a final-cycle state of charge at a discharge rate faster than the charge rate, wherein the increase of the state of charge is at least twice as much as the decrease of the state of charge.

2. The method of claim 1, wherein the method of charging the battery further comprises:
comparing the final-cycle state of a most recent charge cycle of the plurality of charge cycles to the predetermined state of charge; and
charging the battery using another charge cycle of the plurality of charge cycles in response to the final-cycle state of charge of the most recent charge cycle being less than the predetermined state of charge.

3. The method of claim 1, wherein the charge rate of a first charge cycle of the plurality of charge cycles is greater than the charge rate of a last charge cycle of the plurality of charge cycles.

4. The method of claim 1, wherein each of the plurality of charge cycles further comprises:
determining the initial-cycle state of charge based on a current state of charge of the battery or the final-cycle state of charge of a most recent charge cycle; and
determining the charge rate based on the initial-cycle state of charge.

5. The method of claim 1, wherein the discharge rate is at least twice as fast as the charge rate.

6. The method of claim 1, wherein the increase of the state of charge is at least 10 percent of a maximum capacity of the battery and no greater than 40 percent of the maximum capacity of the battery.

7. The method of claim 1, wherein the increase of the state of charge of a charge cycle of the plurality of charge cycles is greater than the increase of the state of charge of another charge cycle of the plurality of charge cycles.

8. The method of claim 1, further comprising charging the battery using constant voltage charging in response to the final-cycle state of charge of a most recent charge cycle of the plurality of charge cycles being equal to or greater than the predetermined threshold state of charge.

9. The method of claim 1, wherein a difference between the charge rate of any one of the plurality of charge cycles and any other of the plurality of charge cycles is less than 0.5C.

10. A battery charging apparatus comprising:
a charger to charge one or more batteries;
a discharger to discharge the one or more batteries; and
a computing apparatus comprising one or more processors operably coupled to the charger and the discharger and configured to charge a battery to a predetermined threshold state of charge using a plurality of charge cycles, each of the plurality of charge cycles comprising:
charging the one or more batteries to increase a state of charge of the battery from an initial-cycle state of charge to an intermediate-cycle state of charge at a charge rate using the charger; and
discharging the one or more batteries to decrease the state of charge of the battery from the intermediate-cycle state of charge to a final-cycle state of charge at a discharge rate faster than the charge rate using the discharger, wherein the increase of the state of charge is at least twice as much as the decrease of the state of charge.

11. The apparatus of claim 10, wherein the discharger comprises:
a load; and
a switch operatively coupled to the load and the computing apparatus to selectively allow discharge of the one or more batteries through the load;
wherein the computing apparatus is configured to operate the switch at a duty cycle during discharge of the one or more batteries, the duty cycle based on a resistance of the load and the discharge rate.

12. The apparatus of claim 11, wherein the switch includes a pulse width modulator.

13. The apparatus of claim 10, wherein the discharger comprises:
a plurality of loads; and
a switching network comprising a plurality of switches, the switching network operatively coupled to the plurality of loads and the computing apparatus and configured to selectively allow discharge of the one or more batteries through one or more of the plurality of loads;
wherein the computing apparatus is further configured to operate the switch network during discharge based on a resistance of each of the plurality of loads and the discharge rate.

14. The apparatus of claim 10, wherein to charge the battery to the predetermined threshold state of charge the computing apparatus is further configured to:
compare the final-cycle state of a most recent charge cycle of the plurality of charge cycles to the predetermined state of charge; and
charge the one or more batteries using another charge cycle of the plurality of charge cycles in response to the final-cycle state of charge of the most recent charge cycle being less than the predetermined state of charge.

15. The apparatus of claim 10, wherein the charge rate of a first charge cycle of the plurality of charge cycles is greater than the charge rate of a last charge cycle of the plurality of charge cycles.

16. The apparatus of claim 10, wherein each of the plurality of charge cycles further comprises:
determining the initial-cycle state of charge based on a current state of charge of the one or more batteries or the final-cycle state of charge of a most recent charge cycle; and
determining the charge rate based on the initial-cycle state of charge.

17. The apparatus of claim 10, wherein the discharge rate is at least twice as fast as the charge rate.

18. A system comprising:
a charging apparatus for charging one or more batteries;
a discharge apparatus for discharging the one or more batteries; and
a battery operatively coupled to the charging apparatus, the battery comprising one or more electrochemical cells; and
a battery management system comprising one or more processors operably coupled to the one or more electrochemical cells and configured to charge the battery to a predetermined threshold state of charge using a plurality of charge cycles, each of the plurality of charge cycles comprising:
charging the battery to increase a state of charge of the battery from an initial-cycle state of charge to an intermediate-cycle state of charge at a charge rate; and
discharging the battery to decrease the state of charge of the battery from the intermediate-cycle state of charge to a final-cycle state of charge at a discharge rate faster than the charge rate, wherein the increase of the state of charge is at least twice as much as the decrease of the state of charge.

19. The system of claim 18, wherein the discharger comprises:
a load; and
a switch operatively coupled to the load and the battery management system to selectively allow discharge of the battery through the load;
wherein the battery management system is configured to operate the switch at a duty cycle during discharge of the battery, the duty cycle based on a resistance of the load and the discharge rate.

20. The system of claim 18, wherein the discharger comprises:
a plurality of loads; and
a switching network comprising a plurality of switches, the switching network operatively coupled to the plurality of loads and the battery management system and configured to selectively allow discharge of the battery through one or more of the plurality of loads;
wherein the battery management system is further configured to operate the switch network during discharge based on a resistance of each of the plurality of loads and the discharge rate.

21. The system of claim 18, wherein to charge the battery to the predetermined threshold state of charge the battery management system is further configured to:
compare the final-cycle state of a most recent charge cycle of the plurality of charge cycles to the predetermined state of charge; and
charge the battery using another charge cycle of the plurality of charge cycles in response to the final-cycle state of charge of the most recent charge cycle being less than the predetermined state of charge.

22. The system of claim 18, wherein the discharge rate is at least twice as fast as the charge rate.

23. The system of claim 18, wherein each of the plurality of charge cycles further comprises:
determining the initial-cycle state of charge based on a current state of charge of the battery or the final-cycle state of charge of a most recent charge cycle; and
determining the charge rate based on the initial-cycle state of charge.

24. The system of claim 18, wherein the battery one or more electrochemical cells are lithium metal electrochemical cells.
